(19) United States
(12) Patent Application Publication
(10) Pub. No.: US 2010/0204350 A1
(43) Pub. Date: Aug. 12, 2010

(54) EXPANDABLE POLYSTYRENE BEAD WITH SUPERIOR ADIABATIC AND FLAMEPROOF EFFECTS AND METHOD OF PRODUCING THE SAME

(76) Inventors: Jae-Cheon Kim, Incheon (KR); Hee-Seop Park, Gyeonggi-do (KR)

Correspondence Address: EGBERT LAW OFFICES, 412 MAIN STREET, 7TH FLOOR, HOUSTON, TX, 77002, US

(21) Appl. No.: 12/602,364

(22) PCT Filed: May 8, 2008
(86) PCT No.: PCT/KR2008/002591

§ 371 Date: Apr. 27, 2010

(30) Foreign Application Priority Data
May 30, 2007 (KR) 10-2007-0052448
Apr. 18, 2008 (KR) 10-2008-0036013

(51) Int. Cl. C08J 9/16; C08J 9/22

(52) U.S. Cl. 521/57; 521/56

(57) ABSTRACT

Disclosed herein is an expandable polystyrene bead having improved adiabaticity and flame-retardance and a method of producing the expandable polystyrene bead. The expandable polystyrene bead comprises 10 to 60 wt % of a flame retardant which is made of one or more selected from among metal or nonmetal oxides, metal or nonmetal hydroxides, silicates, borates and carbonates, having a particle size of 150 μm. Expanded polystyrene foam having improved adiabaticity and flame-retardance can be obtained using the expandable polystyrene bead. A thin flame-retardant thermal insulator including the expanded polystyrene foam can be widely used in various fire-related fields.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to expandable polystyrene beads having improved adiabaticity and flame-retardance and a method of producing the same. More particularly, the present invention relates to expandable polystyrene beads having improved adiabaticity and flame-retardance, including 10-60 wt % of one or more selected from among metal or nonmetal oxides, metalor nonmetal hydroxides, silicates, borates and carbonates as a flame retardant, and a method of producing the same.

2. Description of Related Art including Information Disclosed Under 37 CFR 1.97 and 37 CFR 1.98

Expanded polystyrene foam (Styrofoam) is widely used as a thermal insulator for insulating buildings. Expanded polystyrene foam is advantageous in that it is cheap, light and has high workability, but is disadvantageous in that it is very weak to fire and has lower adiabaticity than extruded polystyrene board (XPS Board). Furthermore, expanded polystyrene foam is disadvantageous in that, since a thicker insulator must be used in order to obtain desired adiabaticity when adiabaticity is not sufficient, its production cost is increased, and the thickness of the inner or outer wall of buildings must be increased.

In order to solve the above problems, conventional technologies for adding expandable graphite in a styrene polymerization process are disclosed.

For example, Korean Unexamined Patent Publication No. 10-2006-0030155, entitled “Method for manufacturing expandable polystyrene particles with excellent thermal insulation capability”, discloses a method of manufacturing expandable polystyrene particles having excellent thermal insulation properties, in which graphite particles are added in a styrene polymerization process, and organic bromine compounds are used as a flame retardant, thus improving the thermal insulation properties of the expandable polystyrene particles.

Korean Unexamined Patent Publication No. 10-2006-0030155, entitled “Method for manufacturing expandable polystyrene particles with excellent thermal insulation capability”, discloses a method of manufacturing expandable polystyrene beads containing graphite by suspending polystyrene particles, obtained through a styrene polymerization process, in water, adding a suspension agent, graphite, an organic flame retardant and a solvent to the water-suspended polystyrene particles to form a mixed solution, heating the mixed solution to a temperature of 120 C, adding a foaming agent to the heated mixed solution, and then leaving the resultant product for 5 hours.

Korean Unexamined Patent Publication No. 10-2007-0053953, entitled “Method for manufacturing expandable polystyrene particles with excellent thermal insulation capability”, discloses a method of manufacturing expandable polystyrene containing graphite by mixing 5 wt % of graphite with polystyrene particles to form a mixture, melting the mixture at a temperature of 220 C, extruding the molten mixture to form mini polystyrene pellets, and then introducing the mini polystyrene pellets into a reactor, mixing the mini polystyrene pellets with water, a suspension agent, an organic flame retardant and a foam adjusting agent to form a mixed solution, heating the mixed solution to a temperature of 120 C, adding a foaming agent (pentane) to the heated mixed solution, maintaining the resultant product for 5 hours, and then dewatering and drying the product.

The above technologies are similar to each other in that the polystyrene includes graphite, except that the preparation processes are different from each other, and are problematic in that, when expanded polystyrene foam is prepared by primarily expanding expandable polystyrene beads, aging the expanded polystyrene beads and then molding the aged polystyrene beads using a commonly-known particle method, the adhesiveness between particles is not good, and thus it is difficult to mold the polystyrene foam. Furthermore, the finally-expanded polystyrene foam is problematic in that its adiabaticity is deteriorated with the passage of time because the graphite included in the polystyrene foam has high adsorptivity. Therefore, these technologies do not have sufficient economic efficiency, and thus have not been put to practical use yet.

In order to solve these problems, as a technology of coating expandable polystyrene beads with aluminum powder, Korean Unexamined Patent Publication No. 10-2007-0076026 discloses expandable polystyrene beads coated with aluminum particles and a method of producing the same, in which plate-shaped aluminum powder is coated with resin (adhesive), and then expandable polystyrene beads are coated with the plate-shaped aluminum using polypropylene wax, polyethylene wax or polystyrene wax.

This technology is conducted using the phenomenon in which aluminum reflects infrared rays, and is problematic in that the improvement of thermal insulation performance is not great although aluminum is expensive, and processes are complicated, so that economic efficiency is insufficient, with the result that this technology has not been put to practical use yet.

Meanwhile, conventional technologies for overcoming insufficient flame retardance, which is another disadvantage of expandable polystyrene beads, are as follows.

Korean Examined Patent Publication No. 10-1999-000001, entitled “Flame-retardant polystyrene resin and method of preparing the same”, discloses a method of preparing a flame-retardant polystyrene resin by adding chlorinated paraffin, antimony oxides, thermally-expandable graphite, and the like, as a flame retardant, to a polystyrene resin.

Korean Unexamined Patent Publication No. 10-1995-018241, entitled “Non-halogen flame-retardant polystyrene resin and method of preparing the same”, discloses a method of preparing a non-halogen flame-retardant polystyrene resin by mixing a polystyrene resin with thermally expandable graphite, red phosphorus, rubber, and the like to form a mixture, and then heating and extruding the mixture.

Korean Unexamined Patent Publication No. 10-2007-0043839, entitled “Synergistic flame-retardant mixture for polystyrene foam”, discloses a method of preparing flame retardant expanded polystyrene foam by mixing polystyrene with a organic bromine compound as a flame retardant and hexabromocyclododecane as a flame-retardance improver to form a mixture and then melting and extruding the mixture at a temperature of 220 C.

The above technologies, which are technologies for adding various additives, such as organic flame retardants, graphite, etc., to polystyrene resin, are all similarly problematic in that the physical properties of the final products are not stable, poisonous gases are generated at the time of burning, and the improvement of flame-retardance is not great.

As a conventional technology for solving the above problems, Korean Unexamined Patent Publication No. 10-2006-0069721, entitled “Method of producing flame-retardant expandable polystyrene beads containing expandable graphite”, discloses a method of producing flame-retardant expandable polystyrene beads by applying steam to expandable polystyrene beads to expand the beads such that the volume thereof is increased to 80 to 130 times, coating the expanded beads with expandable graphite using a thermosetting phenol binder, and then suitably adding an organic flame retardant to the expanded bead coated with the graphite.

This technology, in which a process of coating expanded beads having a very large volume with a flame retardant is required, is problematic in that it incurs a very high machine installation cost, productivity and economic efficiency are insufficient, the quality of final products is not uniform, the improvement of flame retardance is not great, and the expanded beads cannot be easily molded, and thus it has not been put to practical use.

As an attempt to solve the problem, Korean Unexamined Patent Publication No. 10-2006-0069721, entitled “Flame-retardant polystyrene foam and method of producing the same”, discloses a method of producing flame-retardant polystyrene foam by injecting a mixed liquid, in which diatomite, silica, antimony trioxide, and the like are dissolved in a sodium silicate solution, into preformed polystyrene foam. This technology is problematic in that since the mixed liquid injected into the preformed polystyrene is not easily dried, the productivity of polystyrene foam is very low, and in that the polystyrene foam is oxidized due to the chemical reaction between the sodium silicate solution and the added materials with the passage of time, and flame retardance is deteriorated when the foam is dried.

In order to solve all of the above conventional problems, Korean Patent Application No. 10-2006-131769, entitled “Expandable polystyrene bead having improved flame retardance, polystyrene foam using the polystyrene bead and method for producing the polystyrene foam”, filed by the present inventors, was disclosed. In this technology, since the expandable polystyrene beads include 0.5 to 50 wt % of zinc powder, workability is very good, and flame retardance is also greatly improved. However, this technology is problematic in that the production cost of the polystyrene foam is excessively increased because relatively expensive zinc powder is used, and in that the produced polystyrene foam becomes heavy when the amount of zinc powder is increased in order to improve flame retardance.

Accordingly, the present invention has been made keeping in mind the above problems occurring in the prior art, and an object of the present invention is to provide expandable polystyrene (EPS) beads having improved adiabaticity.

Another object of the present invention is to provide expandable polystyrene (EPS) beads having excellent adhesiveness between particles.

A further object of the present invention is to provide expandable polystyrene (EPS) beads having remarkably improved flame retardance.

Yet another object of the present invention is to provide expandable polystyrene (EPS) beads having both improved adiabaticity and improved flame retardance.

Still another object of the present invention is to provide expandable polystyrene (EPS) beads having improved adiabaticity and flame retardance, good workability, and low production cost.

### BRIEF SUMMARY OF THE INVENTION

In order to accomplish the above objects, the present invention provides an expandable polystyrene (EPS) bead, comprising 10 to 60 wt % of a flame retardant which is made of one or more selected from among metal or nonmetal oxides, metal or nonmetal hydroxides, silicates, borates and carbonates, having a particle size of 1 to 50 μm.

### DETAILED DESCRIPTION OF THE INVENTION

Hereinafter, the present invention will be described in detail.

Examples of metal oxides that can be used in the present invention may include ferrous oxide (FeO), ferric trioxide (Fe₂0₃), tri-ferric tetroxide (Fe₃0₄), aluminum oxide, zinc oxide, magnesium oxide, and the like. That is, most metal oxides can be used in the present invention. Examples of the nonmetal oxides may include calcium oxide (CaO), boric acid (H₃B0₃), silica sand (Si0₂), and the like.

Examples of the metal hydroxides may include magnesium hydroxide and aluminum hydroxide, and an example of the nonmetal hydroxide may include calcium hydroxide.

Examples of the silicates may include dried sodium silicate, diatomite, and the like, and an example of the carbonate may include calcium carbonate.

It is preferred that each of the powders of the above materials used in the present invention be fine in order to improve the flame-retardance of the expandable polystyrene bead, and have a particle size of 1-50 μm. The amount of the powder is in a range of 10-60 wt %, and preferably 15-50 wt %. When the amount of the powder is below this range, the flame-retardance of the expandable polystyrene bead is not sufficiently improved, and when the amount thereof is above this range, the flame-retardance of the expandable polystyrene bead is not sufficiently improved either, the expandable polystyrene bead becomes heavy, and the production cost of the expandable polystyrene bead is excessively increased.

Methods of impregnating the expandable polystyrene bead with the flame retardant may include a method of impregnating the expandable polystyrene bead with the flame retardant before or after the polymerization of the expandable polystyrene bead in the preparation of the expandable polystyrene bead and a method of coating a commonly-used expandable polystyrene bead with a flame retardant using a binder. The expression “before the polymerization of the expandable polystyrene bead” means before styrene monomers are 100% polymerized.

Specifically, the method of impregnating the expandable polystyrene bead with the flame retardant may be conducted using the following methods, described in Korean Unexamined Patent Publication No. 10-2007-0080205, filed by the present inventor.

That is, (1) a method of impregnating flame retardant powder into the preformed expandable polystyrene beads when styrene monomers are 90% or more polymerized and thus the beads are gelated in a process of polymerizing the styrene monomers, (2) a method of coating expandable polystyrene beads with flame retardant powder by spraying the flame retardant powder onto the expandable polystyrene beads while the expandable polystyrene beads are transferred to another reactor before the polymerization of styrene monomers is completed in a state in which styrene monomers are 90% or more polymerized, (3) a method of coating expandable polystyrene beads with a flame retardant by mixing the flame retardant with an adhesive binder to form a mixture and then spraying the mixture onto the expandable polystyrene beads, and methods similar thereto may be used.

When the methods (1) and (2) are used, generally, it is difficult to include 5 wt % or more of a flame retardant in an expandable polystyrene bead, and 10 wt % or more of a flame retardant must not be included therein. The reason for this is that, when the amount of the flame retardant is above this range, the physical properties of the expandable polystyrene bead thus obtained are greatly deteriorated.

Therefore, in order to obtain a desired level of flame retardance, when the methods (1) and (2) are used, the amount of the flame retardance is adjusted within 10 wt %, preferably within 5 wt %, and then the method (3) must be supplementarily used.

The method (3) can be directly used even when the methods (1) and (2) are not used. That is, a commonly-used expandable polystyrene bead containing no flame retardant is repeatedly coated with a flame retardant, thus obtaining an expandable polystyrene bead including a flame retardant at a desired level.

In this case, it is preferred that the amount of the adhesive binder be 5 to 20 wt %. As the adhesive binder, one or more selected from among silicon, liquid-phase sodium silicate, oily adhesives, aqueous adhesives, thermosetting adhesives, thermoplastic adhesives and mixtures thereof may be used, as long as they serve to enable a flame retardant to strongly adhere to an expandable polystyrene bead. However, since the expandable polystyrene bead is expanded 80 times or more when it is primarily expanded, it is preferred that thermoplastic adhesives be used as the adhesive binder.

Further, it is preferred that the adhesive binder have a softening point similar to that of polystyrene. The reason for this is that when the difference in the softening point between the adhesive binder and the polystyrene is large, the film formed on the expandable polystyrene bead can be peeled off.

In addition, the expandable polystyrene (EPS) bead can be coated with the flame retardant using a binder formed by dissolving expandable polystyrene (EPS) in an organic solvent, such as toluene, MEK, acetone, or the like, or in an organic mixed solvent consisting of mixtures thereof. When such a binder is used, there are advantages in that the binder does not badly influence the physical properties of the final product because the solid in the binder is the same component as the expandable polystyrene, in that the period for coating the expandable polystyrene bead with the flame retardant using this binder is reduced compared to when other water-soluble adhesive binders are used, and in that waste expandable polystyrene can be reused because it can be melted and then used.

The expandable polystyrene beads obtained through the above methods have excellent adhesiveness. The reason for this, although not clear, is presumed to be that, at the time of molding expandable polystyrene, flame retardant particles infiltrate into expandable polystyrene beads, and thus the expandable polystyrene beads are more strongly bonded with each other. Since the adhesiveness of the expandable polystyrene beads is improved, the adiabaticity of the expanded polystyrene foam obtained using the expandable polystyrene beads is also naturally increased.

In order to further increase the flame-retardance of the expandable polystyrene bead, a predetermined amount of metal powder may be added. When zinc, aluminum, or the like is added in a range of 5 to 20 wt % based on the amount of flame retardant, the flame-retardance thereof can be further increased.

As another method of further improving flame retardance, there may be a method of coating an expandable polystyrene bead containing a flame retardant with liquid-phase sodium silicate. When this method is used, flame retardance is further improved. However, since the liquid-phase sodium silicate has low water-resistance, as disclosed in Korean Unexamined Patent Publication No. 10-2006-0103056, it is preferred that the liquid-phase sodium silicate be used after its water resistance is improved by impregnating potassium or calcium thereinto. The effect of the improvement of flame-retardance is great even when the expandable polystyrene bead is coated only with the sodium silicate-based binder, but this sodium silicate-based binder may be mixed with a flame retardant and then applied on the expandable polystyrene bead.

The present invention may be applied to expandable polypropylene (EPP) particles as well as expandable polystyrene (EPS) beads. Unlike the expandable polystyrene (EPS) beads, the expandable polypropylene (EPP) particles are previously expanded particles. Even when a flame retardant is applied on the surface of the EPP particles, as in the present invention, the flame retardance of the EPP particles can also be improved, the same as the EPS beads.

Unlike conventional technologies requiring additional large-sized equipment, such as a large-sized coating apparatus, a large-sized drying apparatus, and the like, the expandable polystyrene bead of the present invention, obtained through the above methods, can be formed into a compact directly using general polystyrene foam production equipment.

### Advantageous Effects

According to the present invention, polystyrene foam having improved productivity and flame retardance can be obtained without increasing the production cost thereof, and thus the polystyrene foam can be used as interior materials as well as exterior materials for buildings.

Further, according to the present invention, the flame retardance of polystyrene foam can be suitably adjusted, and thus the polystyrene foam can also be effectively applied in fields requiring high flame retardance, such as thermal insulators for fire doors, ships and airplanes.

In addition, according to the present invention, since expandable polystyrene beads, which are fine particles, are directly impregnated with a flame retardant, the size of equipment for producing polystyrene beads can be considerably decreased, and desired flame retardance can be obtained without using organic flame retardants, which generate poisonous gases at the time of a fire.

### Mode for Invention

Hereinafter, the present invention will be described in more detail with reference to the following Examples.

### Comparative Example 1

100 kg of expandable polystyrene beads and 5 kg of ferric trioxide were mixed and stirred in a stirrer, and then 2 kg of a binder, which was prepared by dissolving waste polystyrene foam in toluene and adjusting its solid content to 20%, was sprayed onto the stirred mixture. Subsequently, the sprayed mixture was stirred at a stirring speed of 30 to 60 rpm for 15 minutes and simultaneously dried using hot air, thereby obtaining expandable polystyrene (EPS) beads coated with ferric trioxide. In order to prevent polystyrene particles from coagulating together, 50 plastic balls having a diameter of about 50 mm were introduced into the stirrer to prevent the expandable polystyrene particles from coagulating together in a coating process.

Subsequently, the coated expandable polystyrene (EPS) beads were primarily expanded using steam at a temperature of 100-105 C, and were then secondarily expanded in a mold and then molded to obtain polystyrene foam.

The expanded polystyrene foam thus obtained was light red, had excellent adhesivity between particles, and exhibited excellent flame retardance to such a degree that it did not burn. However, this expanded polystyrene foam did not meet the 3-grade flame retardant material standards prescribed in “Testing method of the flame-retardance of interior finishing materials for buildings” in KSF 1S05660-1 inflammability test.

### Example 1

Expandable polystyrene beads coated with metals, metal oxides and diatomite were obtained using the same method as in Comparative Example 1, except that, after primary coating, 5 kg of zinc powder, 10 kg of diatomite and 15 kg of magnesium hydroxide powder were additionally introduced into a stirrer to form a mixture, and then a binder was sprayed onto the mixture and simultaneously stirred. As in Comparative Example 1, the expanded polystyrene foam prepared using these expandable polystyrene beads was light red, and had excellent adhesiveness between particles. The flame retardance of the expanded polystyrene foam was improved too. Steel plates having a thickness of 0.8 mm were adhered on both sides of the expanded polystyrene foam, and then the flame retardance of the expanded polystyrene foam was tested. As a result, this expanded polystyrene foam satisfied the 3-grade flame retardant material standards.

### Example 2

Expandable polystyrene beads were obtained using the same method as in Example 1, except that, after primary coating, 15 kg of dried sodium silicate powder was additionally introduced into a stirrer to form a mixture, and then a binder was sprayed onto the mixture and simultaneously further stirred to perform secondary coating. As in Example 1, the expanded polystyrene foam prepared using these expandable polystyrene beads were red, and had excellent adhesiveness and flame retardance. Steel plates having a thickness of 0.5 mm were adhered on both sides of the expanded polystyrene foam, and then the flame retardance of the expanded polystyrene foam was tested. As a result, this expanded polystyrene foam satisfied the 3-grade flame retardant material standards.

### Comparative Example 2

Expandable polystyrene beads were obtained using the same method as in Comparative Example 1, except that the binder was replaced by a water-soluble vinyl acetate resin. As in Comparative Example 1, the expanded polystyrene foam prepared using these expandable polystyrene beads was light red, and had excellent adhesiveness between particles. However, the adhesiveness of this expanded polystyrene foam was lower than that in Example 1. The flame retardance of this expanded polystyrene foam was slightly increased compared to general expanded polystyrene foam, but did not meet the 3-grade flame retardant material standards.

### Comparative Example 3

Expandable polystyrene beads were obtained using the same method as in Comparative Example 1, except that aluminum powder was used instead of the ferrous oxide powder. The flame retardance of the expanded polystyrene foam prepared using the obtained expandable polystyrene beads was slightly improved compared to general expanded polystyrene foam, but was lower than that in Comparative Example 1.

### Example 3

Expandable polystyrene beads were obtained using the same method as in Example 1, except that feldspar (Si02 90% or more) was used instead of zinc powder. The physical properties of the expanded polystyrene foam prepared using the secondarily coated beads were similar to those in Example 1.

### Comparative Example 4

Expandable polystyrene beads were obtained using the same method as in Comparative Example 1, except that black ferric tetraoxide was used instead of ferric trioxide. The expanded polystyrene foam prepared using the obtained expandable polystyrene beads had slightly improved adhesiveness between particles compared to that in Comparative Example 1. Further, the physical properties of this expanded polystyrene foam were similar to those in Comparative Example 1, except that the external appearance thereof was black.

### Example 3

The expandable polystyrene beads obtained in Example 2 were additionally coated with 5 kg of borax. The expanded polystyrene foam prepared using the obtained expandable polystyrene beads had excellent adhesiveness between particles. Further, this expanded polystyrene foam had improved flame-retardance compared to that in Example 2.

### Example 4

The expandable polystyrene beads obtained in Example 2 were additionally coated with 20 kg of liquid-phase potassium-based sodium silicate having 35% solid content. The expanded polystyrene foam prepared using the obtained expandable polystyrene beads had excellent adhesiveness between particles. Further, this expanded polystyrene foam had improved flame-retardance compared to that in Example 2. Steel plates having a thickness of 0.5 mm were adhered to both sides of the expanded polystyrene foam, and then the flame retardance of the expanded polystyrene foam was tested. As a result, this expanded polystyrene foam passed the 2-grade flame retardant material standards.

### Comparative Example 5

2.5 kg of polystyrene and 17 kg of styrene were dissolved in a solvent, 1 kg of magnesium hydroxide powder, having an average particle size of 10 μm, was added to the solvent, and then 60 g of dicumyl peroxide and 20 g of dibenzoyl peroxide were additionally added thereto to form a mixed solution. An organic phase included in the mixed solution was mixed in 20 L deionized water in a 50 L stirring tank, and 200 g of pentane was added to the deionized water as a suspension to form a mixed solution, and then the mixed solution was heated to 80 C. After 150 minutes, 3.5 g of an emulsifier (K 30/40, manufactured by Bayer AG corp.) was added to the heated mixed solution.

After 30 minutes, 1190 g of pentane was additionally added thereto, thus completing a polymerization reaction at 135 C. The aqueous phase was separated from the resultant product to obtain expandable polystyrene beads. The flame retardance of the expanded polystyrene foam prepared using the obtained expandable polystyrene beads was improved compared to general expanded polystyrene foam, but did not meet the 3-grade flame retardant material standards. The adhesiveness thereof was somewhat poor compared to that of general expanded polystyrene foam.

### Example 5

The expandable polystyrene beads obtained in Comparative Example 5 were additionally coated through the coating process in Example 1 to obtain coated expandable polystyrene beads. The expanded polystyrene foam prepared using the obtained coated expandable polystyrene beads passed the 3-grade flame retardant material standards. The adhesiveness thereof was similar to that in Comparative Example 2.

### Example 6

Expandable polystyrene beads were obtained using the same method as in Example 5, except that the flame retardant was replaced by calcium carbonate in an additional coating process. The flame-retardance and adhesiveness of the expanded polystyrene foam prepared using the obtained expandable polystyrene beads were similar to those in Example 5.

### Example 7

Expandable polystyrene beads were obtained using the same method as in Example 5, except that magnesium hydroxide and diatomite were replaced by talc in an additional coating process. The flame-retardance and adhesiveness of the expanded polystyrene foam prepared using the obtained expandable polystyrene beads were similar to those in Example 5.

### Example 8

Expandable polystyrene beads were obtained using the same method as in Example 5, except that the expandable polystyrene beads were additionally coated with boric acid in an additional coating process. The flame-retardance and adhesiveness of the expanded polystyrene foam prepared using the obtained expandable polystyrene beads were improved compared to those in Example 5.

We claim:

1. An expandable polystyrene (EPS) bead, comprising: 10 to 60 wt % of a flame retardant which is made of one or more selected from among metal or nonmetal oxides, metal or nonmetal hydroxides, silicates, borates and carbonates, having a particle size of 1 to 50 μm.

2. The expandable polystyrene bead according to claim 1, wherein the metal oxides include ferrous oxide, ferric trioxide, tri-ferric tetroxide, aluminum oxide, zinc oxide, and magnesium oxide.

3. The expandable polystyrene bead according to claim 1, wherein the nonmetal oxides include calcium oxide, boric acid, and silica sand.

4. The expandable polystyrene bead according to claim 1, wherein the metal hydroxides include magnesium hydroxide and aluminum hydroxide.

5. The expandable polystyrene bead according to claim 1, wherein the nonmetal hydroxides include calcium hydroxide.

6. The expandable polystyrene bead according to claim 1, wherein the silicates include dried sodium silicate and diatomite.

7. The expandable polystyrene bead according to claim 1, wherein the borates include borax.

8. The expandable polystyrene bead according to claim 1, wherein the carbonates include calcium carbonate.

9. The expandable polystyrene bead according to claim 1, wherein the flame retardant is included in the expandable polystyrene bead, or is applied thereon.

10. The expandable polystyrene bead according to claim 1, wherein the expandable polystyrene bead comprises 15 to 50 wt % of the flame retardant.

11. A method of producing an expandable polystyrene bead, comprising: coating the expandable polystyrene bead with 10 to 60 wt % of a flame retardant powder which is made of one or more selected from among metal or nonmetal oxides, metal or nonmetal hydroxides, silicates, borates and carbonates, having a particle size of 1 to 50 μm, using an adhesive.

12. The method of producing an expandable polystyrene bead according to claim 11, wherein the adhesive includes vinyl acetate resin, an expandable polystyrene-dissolved solution, acrylic resin, and a liquid-phase sodium silicate solution.

13. The method of producing an expandable polystyrene bead according to claim 12, wherein the liquid-phase sodium silicate solution includes potassium or calcium.

14. The method of producing an expandable polystyrene bead according to claim 12, wherein the liquid-phase sodium silicate solution includes one or more flame retardants selected from among metal or nonmetal oxides, metal or nonmetal hydroxides, silicates, borates and carbonates, having a particle size of 1 to 50 μm.

15. The method of producing an expandable polystyrene bead according to claim 11, wherein an amount of the flame retardant is 15 to 50 wt %.
